(19) United States
(12) Patent Application Publication
(10) Pub. No.: US 2009/0152857 A1
(43) Pub. Date: Jun. 18, 2009

(54) DEBRIS REMOVAL SYSTEM

(76) Inventor: David A. Easley, Tacoma, WA (US)

Correspondence Address: SEED INTELLECTUAL PROPERTY LAW GROUP PLLC, 701 FIFTH AVE, SUITE 5400, SEATTLE, WA, 98104, US

(21) Appl. No.: 12/336,194

(22) Filed: Dec. 16, 2008

Related U.S. Application Data
(60) Provisional application No. 61/014,334, filed on Dec. 17, 2007.

(51) Int. Cl. B60S 1/68; A46B 13/00

(52) U.S. Cl. 280/855; 15/21.1

(57) ABSTRACT

A cleaning device for use with a wheeled apparatus, the device utilizing the rotational motion of at least one of the wheels to clean a portion of an implement, such as a golf club. The device is removably attachable to at least one of the wheels of a golf cart and rotates therewith when the golf cart is in motion. The device may include bristles that rotate with the wheel of the golf cart to remove at least some amount of debris from the golf club when the golf club is held in contact with the rotating bristles. The device, or subcomponents thereof, may be removed from the wheel for storage, security, maintenance, replacement, cleaning, or other purposes.

### BACKGROUND OF THE INVENTION

1. Field of the Invention

The present disclosure generally relates to the cleaning of articles that are used in conjunction with a wheeled apparatus and, more particularly, to a cleaning assembly coupled to the wheel of a golf cart, that removes grass, dirt, sand, and other material from golf clubs, shoes, and the like while the golf cart is in motion.

2. Description of the Related Art

Debris accumulated while playing golf affects the performance of many types golf equipment. FIGS. 1-5 show a number of devices currently used for cleaning golf equipment, such as golf clubs. As can be seen in FIGS. 1, 2, and 3, many of these devices require the user to manually scrub the golf club with a hand-held device.

FIG. 1 shows a device 10 having a handle 12 and a small brush 14 configured to hang from a golf bag for use in cleaning the face of golf clubs. When removed, the device 10 is easy to misplace. The small brush 14 is ineffective in removing stubborn debris and requires the user to manually move the device 10 to remove debris. Additionally, if the user elects to clean a golf club while the device 10 is attached to the golf bag, the removed debris can land on the golf bag.

FIG. 2 presents brush 20 configured to hang from a golf bag or be carried by a golfer. Similar to FIG. 1, the device 20 has a small brush 24 and a handle 22. The brush of FIG. 2 is also ineffective and easily lost.

FIG. 3 shows a battery-powered hand-held golf club cleaner 50 that has a rotating pad or bristles 54 for cleaning a golf club head. In addition to the problems mentioned above with handheld cleaning devices, the user must remember to either charge the batteries or bring extras.

FIGS. 4A and 4B show a tool 40 with the brand name CLUBTUB, which is owned by RWA Golf Co., LLC of Wyoming, Mich. The CLUBTUB is a golf club cleaner that cleans irons, putters, and woods 46. Bristles 44 for removing debris from the golf club head are located in a housing 42, which also contains water. The CLUBTUB tool may be transported on a powered golf cart or located at stationary positions on the golf course. Like the other devices above, the CLUBTUB tool does not utilize any of the kinetic energy of the golf cart to clean the golf clubs.

FIG. 5 shows another approach in which a golf club and golf ball cleaning tool 30 is attachable to a powered golf cart or may be placed on the ground. Similar to the CLUBTUB in FIGS. 4A and 4B, the recess 32 has interior bristles for removing debris from the golf club. Although this device 30 is supported on a powered golf cart, this device does not utilize any of the kinetic energy of the golf cart to clean the golf clubs.

### BRIEF SUMMARY OF THE INVENTION

The embodiments described herein are generally directed to an assembly that can be used to remove at least some amount of debris from a tool or implement, such as a golf club. The debris removal device is removably attachable to at least one of the wheels of a manual three-wheeled golf-bag cart and rotates therewith when the golf-bag cart is in motion. As the wheel rotates, the debris is removed by a sponge, towel, pad, or bristles attached to the wheel of the golf-bag cart. The rotational motion, hence the kinetic energy, of at least one of the wheels of the golf-bag cart knocks debris from the golf club head. For example, in one embodiment, rotating bristles coupled to the wheel of the golf-bag cart remove debris from the golf club when the golf club is placed in contact with the rotating bristles. The device, or subcomponents thereof, may be removed for storage, security, maintenance, replacement, cleaning, or other purposes. The device advantageously permits a golfer to clean one or more golf clubs while in transit from one hole to the next on a golf course, which speeds up game play.

In one embodiment, an assembly is positioned on an apparatus having wheels to remove at least some amount of debris from an implement while the wheeled apparatus is in motion and includes a debris removal device having a first member and a second member for removing debris. The second member is coupled to the first member and configured to remove debris from the implement. The assembly further includes a mounting device detachably coupled to at least one wheel of the wheeled apparatus to couple the first member of the debris removal device to the wheel. The first and second members of the debris removal device rotate as the wheel rotates. Ideally, the device has bristles extending therefrom. Other devices to be attached include a pedometer to track distance or a wet sponge for summer usage.

In another embodiment, a debris removal device for use with a wheel of a golf cart is provided that includes means for removing a debris from a golf club and means for mounting the debris removal means to the wheel of the golf cart. The debris removal means rotates with the wheel of the golf cart to utilize an amount of kinetic energy from the golf cart to remove debris from the golf club while the golf cart is in motion.

In yet another embodiment a cleaning device is provided that includes a debris removal device for removing debris from a golf club, golf shoe, or other golf equipment and a mounting device for mounting the debris removal device to a golf cart. At least a portion of the debris removal device is actuated by the golf cart to remove debris from the golf club while the golf cart is in motion.

In another embodiment a cleaning device is provided with a base having a plurality of bristles extending from the base. The plurality of bristles extends transverse from at least one surface of the base. At least one fastener is coupled to the base and protrudes from the base to couple the base to a wheel on a golf-bag cart or powered golf cart.

In yet another embodiment, a golf cart is provided that includes at least one wheel and a cleaning device having a base with a front and a rear side. A plurality of bristles extends from the front side of the base and at least one fastener couples to the base and protrudes from the rear of the base to attach the cleaning device to the wheel.

### BRIEF DESCRIPTION OF THE SEVERAL VIEWS OF THE DRAWINGS

The foregoing and other features and advantages of the present disclosure will be more readily appreciated as the same become better understood from the following detailed description when taken in conjunction with the accompanying drawings, wherein:

FIG. 1 is an example of an existing golf club debris removal device;

FIG. 2 is an example of an existing golf club debris removal device;

FIG. 3 is an example of an existing golf club debris removal device;

FIGS. 4A and 4B are examples of existing golf club debris removal devices;

FIG. 5 is an example of an existing golf club debris removal device;

FIG. 6 is an isometric view of a manual golf cart having an assembly including a debris removal device mounted to a wheel of the golf cart, according to one embodiment of the present disclosure;

FIG. 7 is an enlarged isometric view of the debris removal device mounted to the wheel of the golf cart of FIG. 6;

FIG. 8 is an enlarged front view of the debris removal device mounted to the wheel of the golf cart of FIG. 6;

FIG. 9 is an enlarged isometric back view of the debris removal device mounted to the wheel of the golf cart of FIG. 6;

FIG. 10 is a front view of a cleaning device according to one embodiment of the present disclosure;

FIG. 11 is a back view of the cleaning device in FIG. 10;

FIG. 12 is an isometric view of the cleaning device of FIG. 10 attached to a wheel of a golf cart;

FIG. 13 is an enlarged side view of the cleaning device of FIG. 12 attached to the wheel of the golf cart;

FIG. 14 is a cross-sectional view of the cleaning device of FIG. 10; and

FIG. 15 is a back view of the cleaning device of FIG. 12 attached to the wheel of the golf cart.

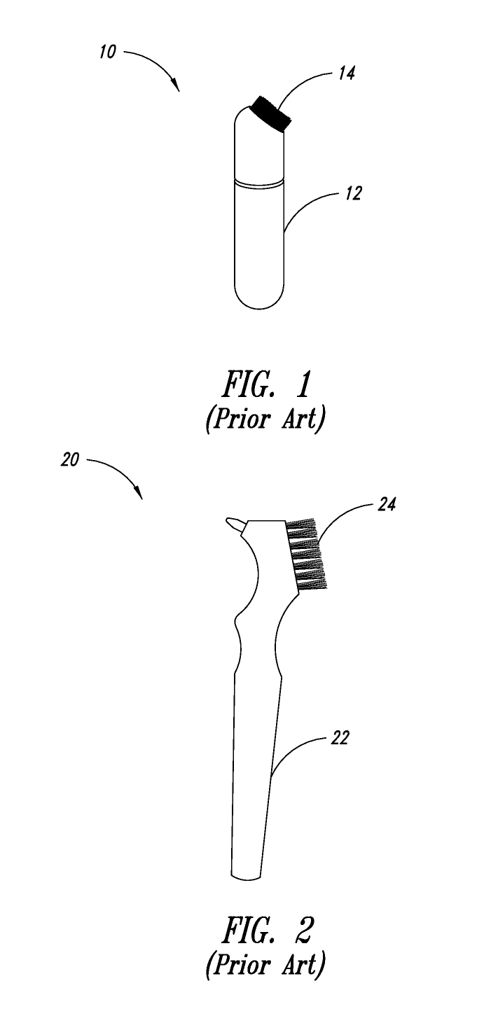

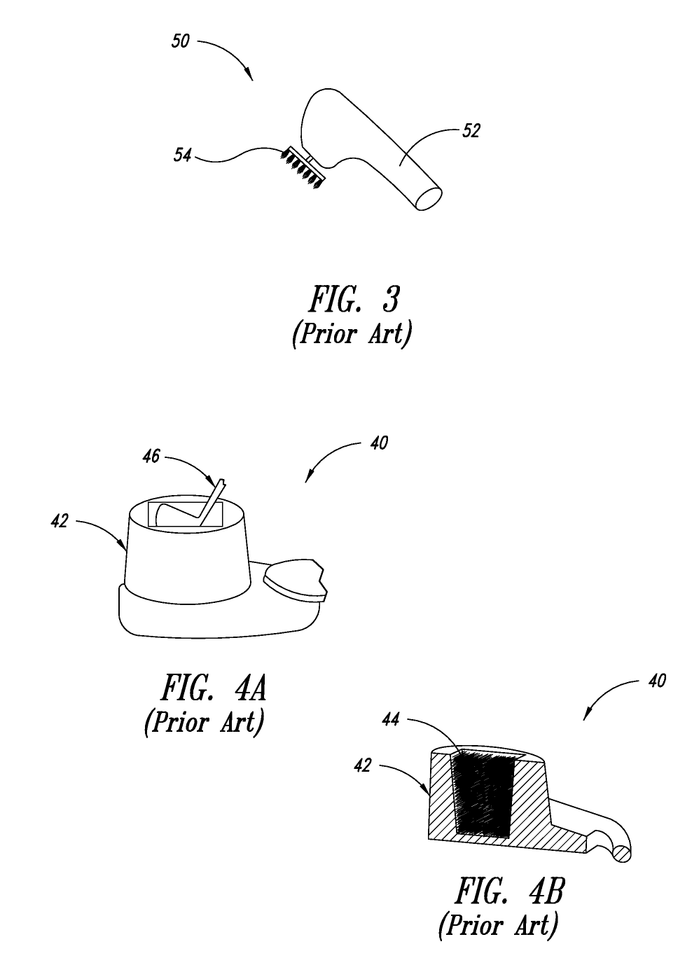

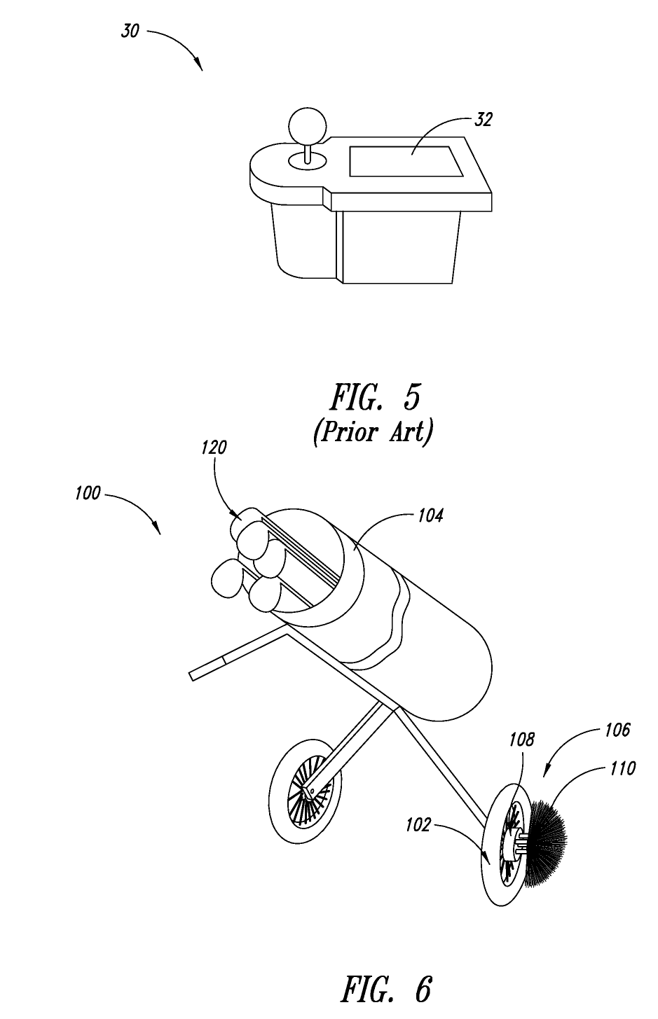

### DETAILED DESCRIPTION OF THE INVENTION

In the following description, certain specific details are set forth in order to provide a thorough understanding of various embodiments of the disclosure. However, one skilled in the art will understand that the disclosure may be practiced without these specific details. In other instances, well-known structures associated with golf instruments, push or pull golf carts, cleaning devices and methods of manufacture have not been described in detail to avoid unnecessarily obscuring the descriptions of the embodiments of the present disclosure.

Unless the context requires otherwise, throughout the specification and claims that follow, the word “comprise” and variations thereof, such as “comprises” and “comprising,” are to be construed in an open, inclusive sense, that is, as “including, but not limited to.”

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the drawings, identical reference numbers identify similar features or elements. The size and relative positions of features in the drawings are not necessarily drawn to scale. For example, the shapes of various features are not drawn to scale, and some of these features are arbitrarily enlarged and positioned to improve drawing legibility.

The present disclosure advantageously permits a golfer to clean debris from a golf club, spikes or cleats of a golf shoe, and other items while moving from one destination to the next with a golf cart 104. To clean a golf club head (iron or wood), for example, the golfer holds a handle of the golf club and extends the head of the golf club into contact with a rotating debris removal device 106. It is understood and appreciated that removing debris from the golf club may include removing grass, dirt, sand, mud, or other particulates accumulated during play, reducing moisture or other built-up residue, and shining or polishing the golf club head.

Referring to FIG. 6, an assembly 100 for cleaning golf implements 120 is shown in accordance with one embodiment of the present disclosure. The assembly 100 utilizes the rotational motion of a wheel 102 on a golf cart 104 to remove debris from the golf implement 120. A debris removal device 106 is detachably coupled to the wheel 102 by fasteners 124 so that the debris removal device 106 will rotate with the wheel 102 while the golf cart 104 is in motion.

The wheeled golf cart 104 shown in FIG. 6 is a manual, push/pull type of golf cart with two wheels. Another type of manual cart is a three-wheeled push/pull golf cart. The wheels of a three-wheeled cart are typically arranged in a tricycle formation. However, the debris removal device 106 may be adapted for use with any type of wheeled golf cart, including a powered three-wheeled or four-wheeled golf cart (e.g., gas, electric, solar, or other similar power input) where a user sits in the cart. Preferably the debris removal device 106 is removably attached to one of the rear wheels of the three-wheeled cart. Such an arrangement facilitates maneuvering of the golf club head into a position to be cleaned by the debris removal device 106 as the wheel rotates.

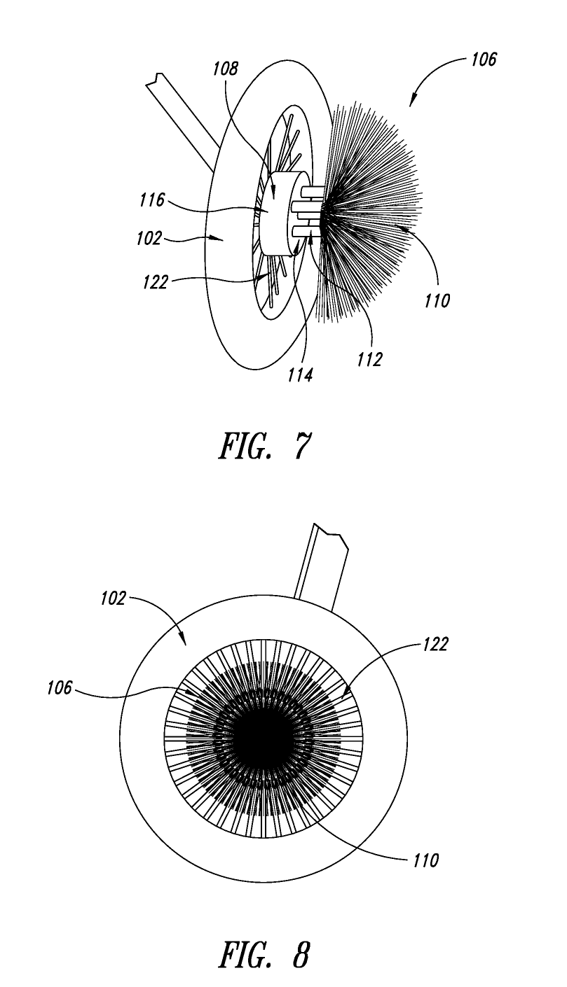

FIG. 7 is an enlarged view of the wheel 102 from the two-wheeled cart 104 fitted with the debris removal device 106 of FIG. 6. The debris removal device 106 includes a first member 108 coupled to a second member 110 by a plurality of fasteners 124. The first member 108 and the second member 110 are separated by hollow spacers 112 that receive the fasteners 124. In one embodiment the first member 108 is a plate, a base, or a hub that is sized and shaped for secure yet removable attachment to the wheel 102 of the golf cart 104 by the fasteners 124. The first member 108 will be described in more detail herein below.

In a preferred embodiment, the second member 110 is a cleaning element, in this case a plurality of bristles. However, the cleaning element may be a sponge, a towel, a pad, a brush, or other item that provides sufficient texture to remove debris from the golf implement, such as a golf club. The second member 110 may include a base or a plate onto which the cleaning element is attached. In one embodiment, the second member 110 is a plurality of single-strand fibers that couple to a base with a first end of the bristles attached to the base and a second end of the bristles extending away from the base. The bristles may be formed of natural or synthetic fibers.

In an alternative embodiment, the bristles of the second member 110 are doubled back with both free ends coupled to the base. The doubled-back or middle portion of the fiber freely extends from the base. It is understood that the thickness, texture, material, color, or configuration of the bristles are variable parameters that are subject to change depending on the intended use as well as the goals of the designer, customer, retailer, manufacturer, or user. For example, as shown in FIGS. 6 and 7, the plurality of bristles of the second member 110 may be configured to form a dome shape as they extend from the base. The dome shape provides a consistent surface when the debris removal device 106 rotates with the wheel 102, creating a consistent surface that makes it easier for the user to hold the head of a golf club against the cleaning surface (i.e., the bristles). as the wheel 102 rotates the debris removal device 106.

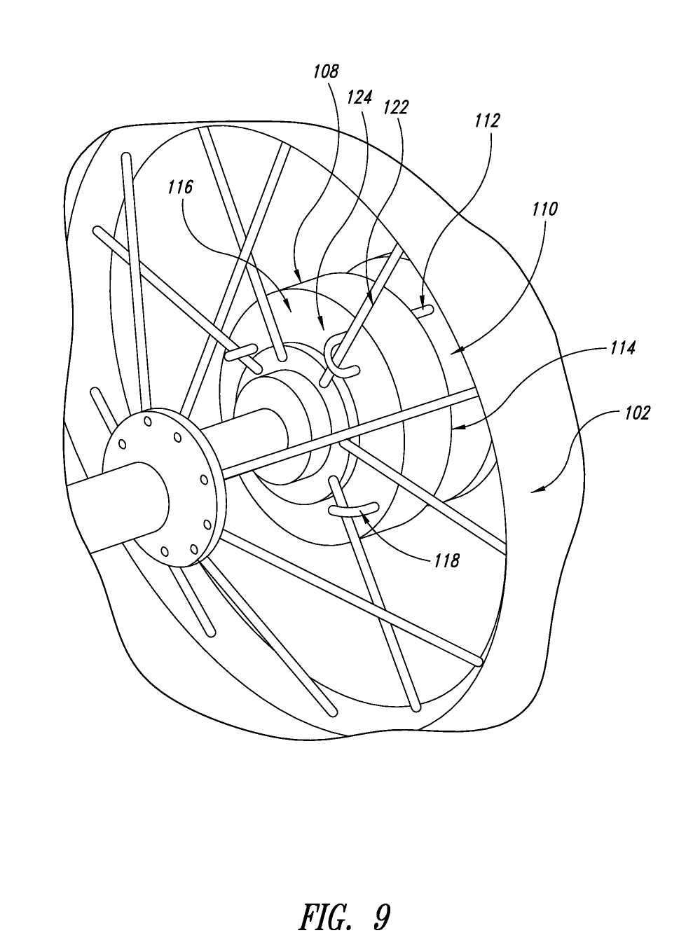

FIG. 8 is an enlarged front view of the debris removal device 106 attached to the wheel 102. Preferably, the debris removal device 106 is centered on the wheel 102 so that the central axis is aligned with the rotational axis of the wheel 102 to provide a consistent cleaning surface as the wheel rotates. However, the debris removal device 106 may be attached in any manner that allows rotation of the debris removal device 106 with the wheel 102.

As can be seen in FIG. 9, the first member 108 is a mounting mechanism formed to have a first side 114 (the front) and a second side 116 (the rear). The mounting device 108 couples the second member 110 to the spokes 122 of the wheel 102. The first side 114 of the mounting device 108 faces away from the wheel 102 and toward the second member 110. The second side 116 of the mounting device 108 faces the spokes 122 of the wheel 102 of the golf cart. A plurality of fasteners 124 protrude from the second side 116 of the mounting device to couple the debris removal device 106 to the spokes 122 of the wheel 102. It is understood that the debris removal device 106 may be attached to the hub of a wheel instead of the spokes or in any manner that provides sufficient support for the debris removal device 106.

In a preferred embodiment the fasteners 124 are U-bolts that have a U-shaped portion 118 at one end and a threaded portion at the other end for receiving a nut. The U-bolts 124 pass through openings formed in the first member 108 (the mounting mechanism) and the second member 110 of the debris removal device 106 to engage the spokes 122 of the wheel 102. The openings formed in the first member 108 and the second member 110 of the debris removal device have longitudinal axes that are preferable aligned with and parallel to the rotational axis of the wheel 102. The threaded portion of the U-bolts 124 extends from the second member 110 a sufficient distance to accommodate the fastener or nut. The U-bolts 124 are a sufficient length to extend the U-shaped portions 118 from one end of the hollow spacers 112 and the threaded portion to the opposite end of the hollow spacers 112. The U-shaped portions 118 of the U-bolts 124 extend from the second side 116 of the mounting device 108 and loop around the spokes 122 of the wheel 102. The nuts, which can be acorn nuts, wing nuts, or other threaded tightening devices, are received on the threaded portions of the U-bolts 124. Secure attachment of the debris removal device 106 to the wheel 102 ensures rotation of the debris removal device 106 as the wheel 102 rotates when the golf cart 104 is in motion.

The debris removal device 106 and its subcomponents are detachable from the wheel 102 of the golf cart for storage, security, maintenance, replacement, or other purposes. The assembly advantageously utilizes the motion of a golf cart (i.e., the kinetic energy of the golf cart) to clean golf clubs while the golf cart is in motion. This may reduce the amount of non-playing time on the golf course, and in turn increase the overall average speed of play on the course.

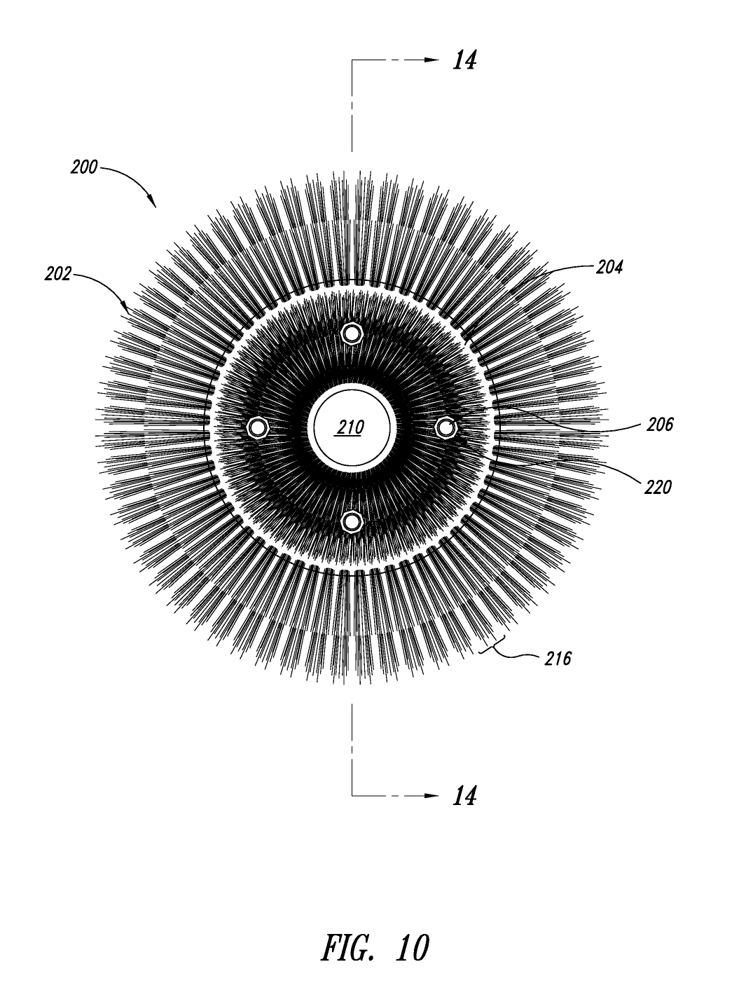

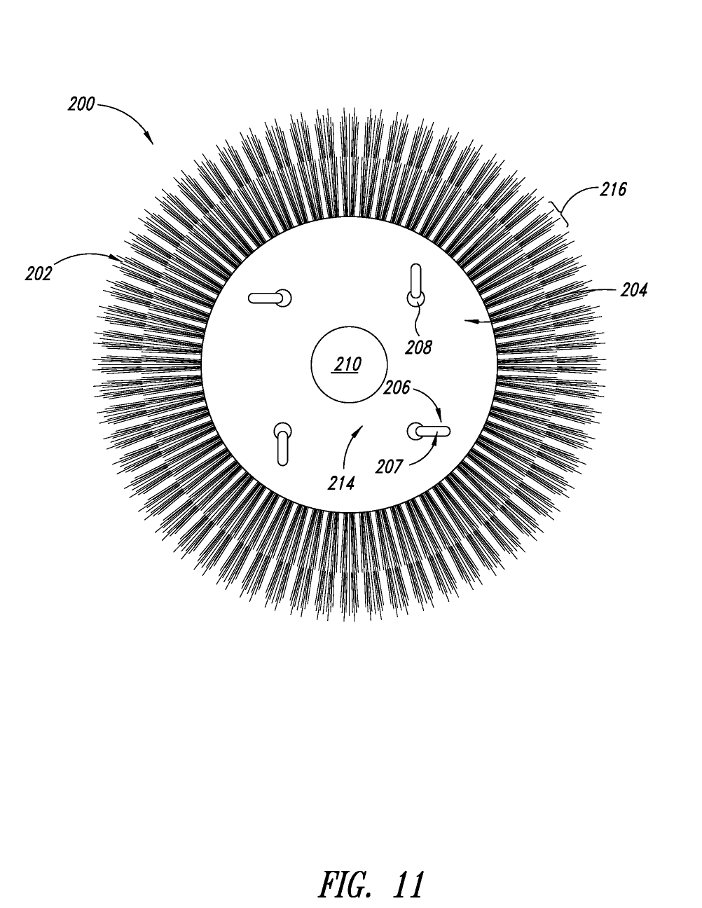

FIG. 10 is a front view of an alternate embodiment of the present disclosure. Shown therein is a cleaning device 200 that includes a base 204 formed of a solid material from which extends a plurality of bristles 202. The base 204 may be formed of molded plastic, rubber, metal, or any other material sturdy enough to firmly hold the bristles 202. To reduce weight, the base 204 may be hollow or have hollow portions formed therein.

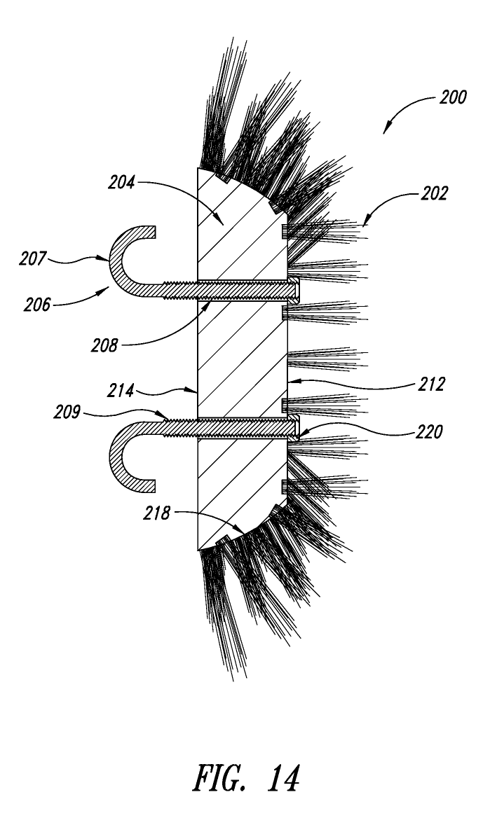

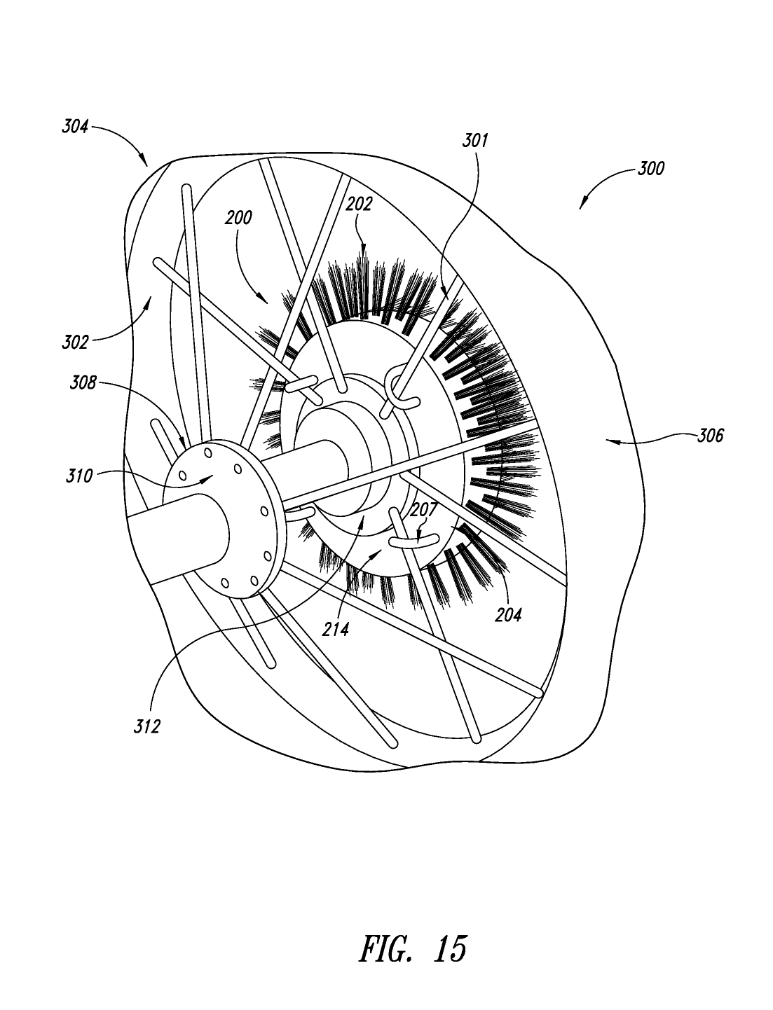

The base 204 and the bristles 202 must withstand the force exerted when the user holds a golf implement against the cleaning device 200 for removal of debris. The base 204 may be sized and shaped as a circular mound or dome with two mutually opposing planar front and rear surfaces 212, 214 as shown in FIG. 14. Preferably the front surface 212 has a smaller diameter than the rear surface 214, thereby forming an angled face 218 connecting the front surface 212 and the rear surface 214. A base having a circular cross-sectional configuration is preferable because it provides a constant surface area as the wheel spins. In one embodiment, the rear surface 214 has a diameter of 4.5 inches and the front surface has a diameter of 3 inches. It is to be understood that while a circular geometric configuration is used, other geometric shapes can be used.

As shown in FIG. 10, a large central bore 210 is provided transverse to the front surface 212 and rear surface 214 of the base 204. The diameter of the central bore 210 may be varied. Larger diameters will create a recess into which the head of the golf club may be inserted to increase the number of bristles in contact with the head. The central bore 210 is not essential, however, and it may be filled in. In another embodiment, a concave configuration of the base 204, or an indentation in the base 204, may provide a recessed area into which the head of the golf club may be inserted to increase bristle contact, provide deeper scrubbing, and produce a more thorough cleaning. The base 204 in FIG. 10 also includes four smaller through-holes 208 for receiving the fasteners 206 (see FIG. 14). These smaller through-holes 208 are also formed transverse to the front surface 212 and rear surface 214 of the base 204 and are evenly spaced around the base 204. The specific number and location of the through-holes 208 may be modified to meet the dimensions and features of the wheel on which the cleaning device 200 will be mounted.

The bristles 202 as shown in FIG. 10 are grouped in clusters 216. Arranging the bristles in clusters provides a firm, reinforced, and abrasive surface to remove accumulated debris from the golf implement. Each bristle 202 in the clusters 216 has one end securely embedded in the base 204 with an opposite end that extends away from the base. The bristles may be individually inserted into the base 204 instead of in clusters. The bristles 202 are secured to the base 204 using known methods and hence their attachment will not be described in detail herein. Alternatively, a longer bristle may be used where the bristle is bent in the middle so that both ends of a bristle extend out of the base 204. The bend in the middle of the single bristle may be inserted into a single hole in the base 204 or threaded through a hole formed in the base 204.

In a preferred embodiment, the bristles are nylon with a diameter in the range of 10,000th to 30,000th of an inch. The bristles may alternatively be formed of natural or synthetic fibers, including plastic, metal, or wood. The length of the bristles 202 extending from the base 204 is generally in the range of 1 inch to 1.75 inches. The device 200 may be formed so that longer bristles are attached near the perimeter of the base 204 and shorter bristles are mounted on the dome portion near a center of the base 204.

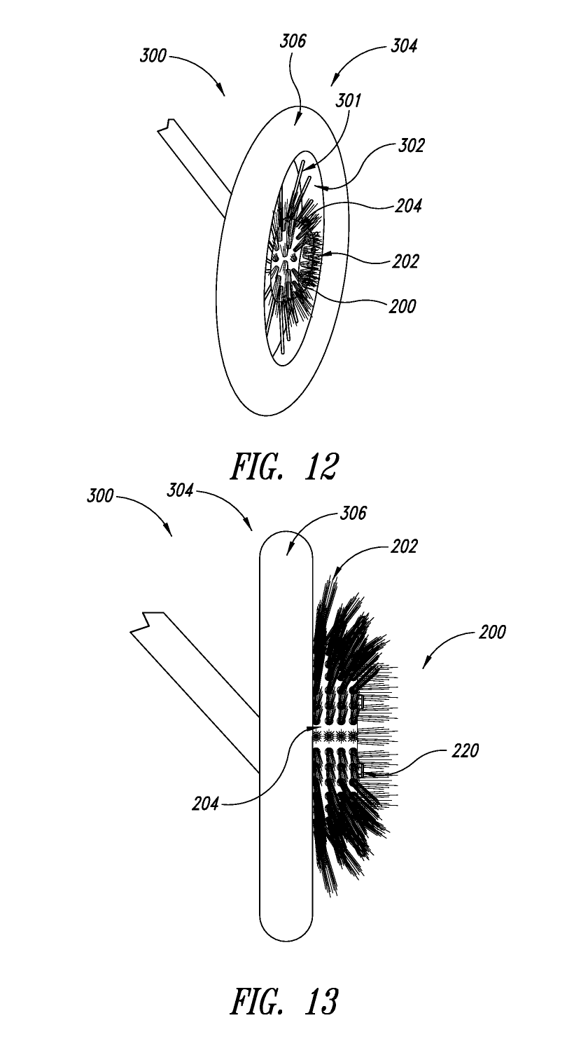

FIG. 11 is a back view of the cleaning device 200 of FIG. 10. The clusters 216 of bristles 202 extend radially from the circular base 204. The fasteners 206 are preferably bolts that have a threaded portion 209 and a hook portion 207. The hook portion 207 extends from the rear surface 214 of the base 204 to couple the cleaning device 200 to a wheel 304, and in particular to the spokes 301 of the wheel 304 (see FIG. 12). By tightening a nut 220 over the threaded portion 209 of the bolts 206, the cleaning device 200 becomes securely attached to the spokes 301 of the wheel 304 (see FIGS. 14 and 15). Secure attachment ensures stability of the cleaning device 200 as the wheel 304 rotates, which is important to facilitate the contact of the bristles 202 with the head of a golf club guided by the user.

FIGS. 12 and 13 illustrate an assembly 300 that includes the cleaning device 200 detachably coupled to the spokes 301 of the wheel 304 of a golf cart. The wheel 304 includes a rubber tire 306, a spindle 308, a metal rim 302, and spokes 301 that connect the metal rim 302 with the spindle 308. The spindle 308 has an interior flange 310 and an exterior flange 312 to which the spokes 301 are connected. The fasteners 206 attach the base 204 so that the rear face 214 bears against the exterior flange 312 of the spindle 308. The bristles 202 extend away from the exterior flange 312, transverse to the angled face 218 of the base 204, and transverse to the front surface 212. Providing the bristles on the angled face 218 and on the front surface 212 maximizes the surface area covered by the debris removing bristles and accommodates the positioning of the golf implement in a variety of orientations. It is understood that bristles may be provided on only one of these faces.

FIG. 14 illustrates a cross-section, 14-14, of the device 200 shown in FIG. 10. A preferred shape of the base 204 is shown having the front surface 212 that is smaller in diameter than the rear surface 214 as previously described. The differences in diameter create the angled face 218 between the front and rear surfaces. The cross-section passes through two of the four smaller through-holes 208 of FIG. 10. The smaller through-holes 208 are sized and shaped to securely receive threaded bolts 206. The through-holes 208 are formed transverse to the front surface 212 and rear surface 214.

FIG. 15 illustrates a preferred embodiment of the assembly 300 wherein the cleaning device 200 is detachably coupled to the spokes 301 of a wheel 304 of the golf cart. Other fastening means may be used to attach the debris removal device to the wheel 304. For example, a flexible fastener could be passed through a first bore in a manner where the fastener passes between two spokes of the wheel, behind the exterior flange 312, through two spokes on the opposite side of the exterior flange 312, and through a second through-hole diagonal from the first through-hole.

The cleaning device 200 may be cleaned while attached to the wheel of the golf cart by spraying the cleaning device 200 with water, i.e., from a water hose, or simply by pouring water over the cleaning device. Additionally, the cleaning device may be removed from the wheel and submerged in water or shaken to remove accumulated debris.

In an alternate embodiment, a brace is provided that attaches to the frame of the golf cart to assist the user in bracing the club head against the device 200 while the golf cart is in motion. The support helps to balance the forces exerted on the club and provides a fulcrum for leveraging the club head against the bristles or other cleaning device as the wheel of the golf cart rotates. The brace is detachably coupled to the frame of the golf cart in a position that assists the user in guiding and holding the golf club head in contact with the bristles while the user pulls or otherwise moves the cart. The brace can be attached by clamps, screws, magnets, or the like, or it can be integrally formed with the cart. Preferably, the brace is positioned so the lower portion of the club shaft (nearest the head) bears or rests against the brace close to the wheel, thus maximizing the leverage to the user while holding the handle of the club.

Further, the embodiments disclosed herein can be configured for use on a variety of golf carts made by numerous golf cart manufactures. Moreover, they can be adapted to other wheeled devices and vehicles, such as, without limitation, strollers, tricycles, bicycles, shopping carts, and the like.

All of the above U.S. patents or patent applications referred to in this specification and/or listed in the Application Data Sheet are incorporated herein by reference, in their entirety.

From the foregoing it will be appreciated that, although specific embodiments of the present disclosure have been described herein for purposes of illustration, various modifications may be made without deviating from the spirit and scope of the present disclosure. Accordingly, the present disclosure is not limited except as by the appended claims.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. An assembly positioned on an apparatus having wheels to remove at least some amount of debris from an implement while the wheeled apparatus is in motion, the assembly comprising:
a debris removal device having a first member and a second member coupled to the first member and configured to remove debris from the implement;
a mounting device detachably coupled to at least one wheel of the wheeled apparatus and configured to couple the first member of the debris removal device to the wheel, wherein the first and second members of the debris removal device rotate as the wheel rotates.

2. The assembly of claim 1 wherein the second member comprises a plurality of at least one from among bristles, a sponge, a pad, and a towel.

3. The assembly of claim 1 wherein the first member is a plate.

4. The assembly of claim 1 wherein the mounting device comprises a plurality of fastening mechanisms that couple the first member of the debris removal device to the second member of the debris removal device and to the wheel.

5. The assembly of claim 1 wherein an implement support couples to the wheeled apparatus, the implement support formed to support the implement in contact with the debris removal device as the wheel rotates.

6. A debris removal device for use with a wheel of a golf cart, comprising:
means for removing debris from a golf club; and
means for mounting the debris removal means to the wheel of the golf cart, wherein the debris removal means rotates with the wheel of the golf cart to utilize an amount of kinetic energy from the golf cart to remove debris from the golf club while the golf cart is in motion.

7. The debris removal device of claim 6 wherein the debris removal means comprises a plurality of bristles.

8. The debris removal device of claim 6 wherein the mounting means comprises a hub and a plurality of fasteners, the fasteners coupling the hub to the wheel of the golf cart.

9. A cleaning device, comprising:
a debris removal device for removing debris from a golf club, golf shoe, or other golf equipment; and
a mounting device for mounting the debris removal means to a golf cart, wherein at least a portion of the debris removal device is actuated by the golf cart to remove debris from the golf club while the golf cart is in motion.

10. The cleaning device of claim 9 comprising a support for supporting the golf club in contact with the debris removal device while the golf cart is in motion.

11. A cleaning device, comprising:
a base having a front and a rear side;
a plurality of bristles extending from the front side of the base, the plurality of bristles extending transverse from at least one surface of the front side of the base;
at least one fastener coupled to the base and protruding from the rear of the base to couple the base to a wheel.

12. The cleaning device of claim 11 wherein the base is formed with at least one bore through the base, the at least one bore formed transverse to the front and rear sides of the base.

13. The cleaning device of claim 12 wherein the bore is sized and shaped to receive the at least one fastener therethrough.

14. The cleaning device of claim 11 wherein the fastener comprises a nut, a threaded portion, and a hook member, the threaded portion sized and shaped to receive the nut on the front side of the base, and the hook portion sized and shaped to extend from the rear side of the base.

15. A golf cart, comprising:
at least one wheel; and
a cleaning device having a base, a plurality of bristles extending from the base, and at least one fastener coupled to the base and protruding from the base to couple the cleaning device to the wheel.

16. The golf cart of claim 15 comprising a support attached to the golf cart for supporting a golf club in contact with the cleaning device while the golf cart is in motion.

17. The golf cart of claim 15 wherein the base of the cleaning device is formed with at least one bore through the base, the at least one bore formed transverse to the base.
